(19) United States
(12) Patent Application Publication
(10) Pub. No.: US 2022/0413195 A1
(43) Pub. Date: Dec. 29, 2022

(54) DIFFRACTIVE OPTICAL ELEMENT AND METHOD OF MANUFACTURING DIFFRACTIVE OPTICAL ELEMENT

(71) Applicant: FUJIFILM Corporation, Tokyo (JP)

(72) Inventors: Masanori FUJIWARA, Saitama-shi (JP); Seiichi WATANABE, Saitama-shi (JP); Yasunori MURAKAMI, Saitama-shi (JP)

(73) Assignee: FUJIFILM Corporation, Tokyo (JP)

(21) Appl. No.: 17/902,892

(22) Filed: Sep. 4, 2022

Related U.S. Application Data
(63) Continuation of application No. PCT/JP2021/005119, filed on Feb. 10, 2021.

(30) Foreign Application Priority Data
Mar. 31, 2020 (JP) 2020-063803

(51) Int. Cl. G02B 5/18; B29D 11/00

(52) U.S. Cl. CPC G02B 5/1852; B29D 11/00769

(57) ABSTRACT

A diffractive optical element includes: a first material layer that has a diffractive grating shape; and a second material layer that is laminated on the first material layer, the diffractive grating shape forming a plurality of concentric annular ring zones in a plan view from a lamination direction of the first material layer and the second material layer, and a radius of an innermost first ring zone among the plurality of ring zones is less than any one of distances between the ring zones.

### CROSS REFERENCE TO RELATED APPLICATION

This is a continuation of International Application No. PCT/JP2021/005119 filed on Feb. 10, 2021, and claims priority from Japanese Patent Application No. 2020-063803 filed on Mar. 31, 2020, the entire disclosures of which are incorporated herein by reference.

### BACKGROUND OF THE INVENTION

### 1. Field of the Invention

The present invention relates to a diffractive optical element and a method of manufacturing a diffractive optical element.

### 2. Description of the Related Art

JP2007-041542A discloses a technique of preventing the shape of a stepped surface and its vicinity from collapsing and maintaining high diffraction efficiency in a case where a scanning lens having a diffractive lens structure is manufactured by injection molding.

JP2019-032518A discloses a method of reducing deformation of a lens surface due to cure shrinkage of a resin in a case where the diffractive optical element is produced by curing the resin.

JP2015-011293A discloses a technique of reducing a phase shift of transmitted wavefront of light transmitted through a diffractive optical element.

### SUMMARY OF THE INVENTION

In a case where a diffractive optical element is manufactured by cementing two materials, it is difficult to bring the optical characteristics into a desired state due to the shrinkage stress during curing of the materials. In JP2019-032518A and JP2015-011293A, the manufacturing process is complicated. JP2007-041542A manufactures a diffractive lens structure by injection molding, and does not relate to a technique of manufacturing a diffractive optical element by cementing two materials.

An object of the present invention is to provide a diffractive optical element capable of easily obtaining desired optical characteristics and a method of manufacturing the same.

According to an aspect of the present invention, there is provided a diffractive optical element comprising: a first material layer that has a diffractive grating shape; and a second material layer that is laminated on the first material layer, the diffractive grating shape forming a plurality of concentric annular ring zones in a plan view from a lamination direction of the first material layer and the second material layer. A radius of an innermost first ring zone among the plurality of ring zones is less than any one of distances between the ring zones.

According to an aspect of the present invention, there is provided a diffractive optical element comprising: a first material layer that has a diffractive grating shape; and a second material layer that is laminated on the first material layer, the diffractive grating shape forming a plurality of concentric annular ring zones in a plan view from a lamination direction of the first material layer and the second material layer. In a case where, assuming that a reference wavelength is λ, a difference in refractive index between the first material layer and the second material layer is Δn, a radius of each ring zone is r, an even-order phase difference function at the radius as a variable is φ(r), a start phase of the phase difference function is C, and a remainder obtained by dividing the added value of φ(r) and C by 2π is MOD(r), and a shape of a structure forming each ring zone is defined by Expression obtained by dividing MOD(r)×λ by 2π×Δn, C is greater than 0 and less than 2π.

According to an aspect of the present invention, there is provided a method of manufacturing a diffractive optical element having a first material layer that has a diffractive grating shape and a second material layer that is laminated on the first material layer, the diffractive grating shape forming a plurality of concentric annular ring zones in a plan view from a lamination direction of the first material layer and the second material layer. The method comprises forming a radius of an innermost first ring zone among the plurality of ring zones to be less than any one of distances between the adjacent ring zones.

According to an aspect of the present invention, there is provided a method of manufacturing a diffractive optical element having a first material layer that has a diffractive grating shape and a second material layer that is laminated on the first material layer, the diffractive grating shape forming a plurality of concentric annular ring zones in a plan view from a lamination direction of the first material layer and the second material layer. In a case where, assuming that a reference wavelength is λ, a difference in refractive index between the first material layer and the second material layer is Δn, a radius of each ring zone is r, an even-order phase difference function at the radius as a variable is φ(r), a start phase of the phase difference function is C, and a remainder obtained by dividing the added value of φ(r) and C by 2π is MOD(r), and a shape of a structure forming each ring zone is defined by Expression obtained by dividing MOD(r)×λ by 2π×Δn, the structure is designed in a state where C is greater than 0 and less than 2π, and the diffractive grating shape is formed in accordance with the design.

According to the present invention, desired optical characteristics can be easily obtained.

### BRIEF DESCRIPTION OF THE DRAWINGS

FIG. 1 is a schematic cross-sectional view showing a configuration of a diffractive optical element 100 according to an embodiment of a diffractive optical element of the present invention.

FIG. 2 is a schematic plan view of the diffractive optical element 100 shown in FIG. 1 as viewed in a direction D.

FIG. 3 is a schematic cross-sectional view showing a modification example of the diffractive optical element 100 shown in FIG. 1.

FIG. 4 is a schematic cross-sectional view showing another modification of the diffractive optical element 100 shown in FIG. 1.

FIG. 5 is a schematic diagram for explaining a graph of a phase difference function φ(r) and an example of a shape of a structure Sₙ determined on the basis of the graph.

FIG. 6 is a schematic diagram showing a configuration of a first inspection example.

FIG. 7 is a diagram showing results of the first inspection example.

FIG. 8 is a diagram showing the results of the first inspection example.

FIG. 9 is a schematic diagram showing a configuration of a second inspection example.

FIG. 10 is a diagram showing results of the second inspection example.

FIG. 11 is a diagram showing the results of the second inspection example.

FIG. 12 is a diagram showing the results of examples.

### DESCRIPTION OF THE PREFERRED EMBODIMENTS

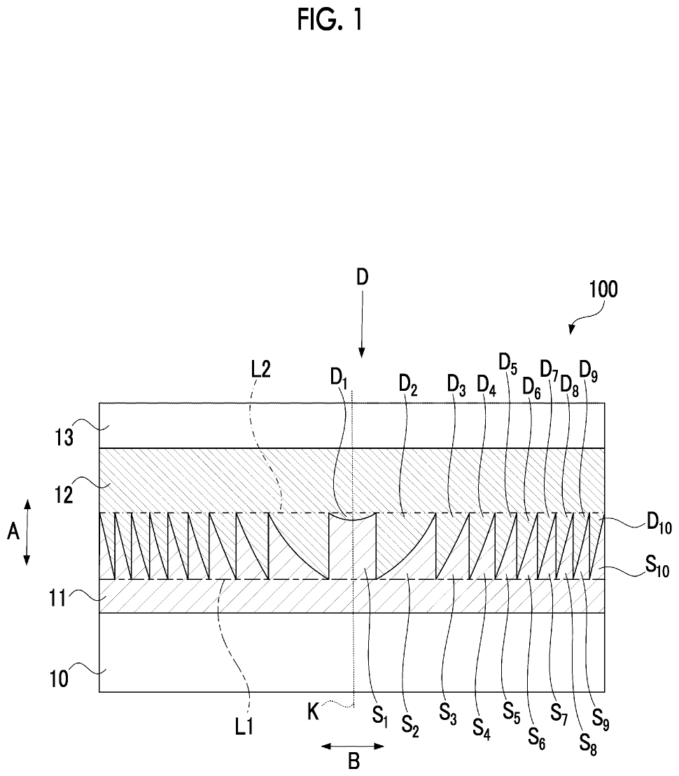

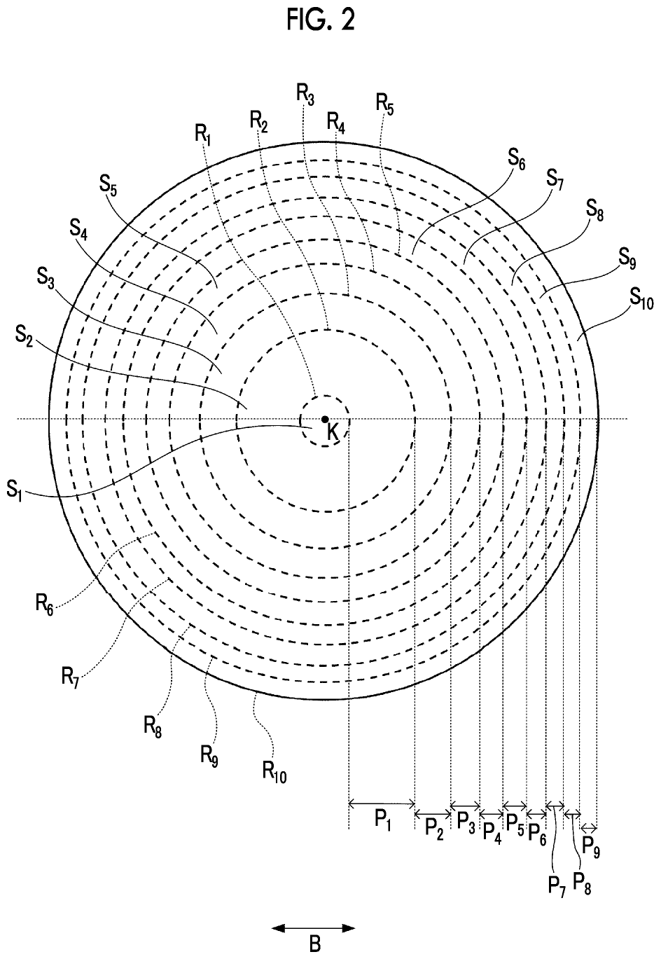

Hereinafter, an embodiment of the present invention will be described, with reference to the drawings. FIG. 1 is a schematic view of a cross section which passes through an optical axis showing a configuration of a diffractive optical element 100 as an embodiment of the diffractive optical element of the present invention. FIG. 2 is a schematic plan view of the diffractive optical element 100 shown in FIG. 1 as viewed in a direction D.

The diffractive optical element 100 comprises a glass lens 10, a first material layer 11 that has a refractive index N1 and is laminated on a surface of one side of a direction A which is a direction of an optical axis K of the glass lens 10, a second material layer 12 that has a refractive index N2 and is laminated on the first material layer 11, and a glass lens 13 that is laminated on the second material layer 12. The first material layer 11 and the second material layer 12 are layers including a resin, respectively. The resin used for the first material layer 11 and the second material layer 12 is selected so as to satisfy a diffraction condition Δnd=λ. Here, λ, is a wavelength of light, Δn is a difference in refractive index between the first material layer 11 and the second material layer 12 with respect to the light having the wavelength λ, and d is a height of a diffractive grating. In order to obtain high diffraction efficiency in a wide wavelength band, it is preferable that a resin having a high refractive index and low dispersion is used for one of the first material layer 11 and the second material layer 12 and a resin having a low refractive index and high dispersion is used for the other thereof. For the first material layer 11 and the second material layer 12, for example, it is possible to use an ultraviolet curable resin. Examples of the ultraviolet curable resin include an acrylate-based resin and an epoxy-based resin. As the ultraviolet curable resin, an acrylate-based resin is particularly preferable. The first material layer 11 and the second material layer 12 may each include metal or metal oxide particles. Examples of the particles, which are included in the first material layer 11 and the second material layer 12, include titanium oxide, zirconium oxide, indium tin oxide, antimony oxide, and the like. For example, the refractive index N1 is lower than the refractive index N2. The lamination direction of the glass lens 10, the first material layer 11, the second material layer 12, and the glass lens 13 coincides with the direction A in which the optical axis K extends. A direction orthogonal to the direction A is described as a direction B. A direction from the glass lens 13 to the glass lens 10 in the direction A is referred to as the direction D.

In FIG. 1, the glass lens 10 and the glass lens 13 are shown in a flat plate shape, respectively. However, these shapes have an optional shape such as a concave lens shape or a convex lens shape, in accordance with the optical characteristics or applications required for the diffractive optical element 100. The glass lens 10 and the glass lens 13 may be respectively resin lenses.

The diffractive optical element 100 is manufactured by providing a glass lens 10 having the first material layer 11 formed on the surface thereof by a mold or the like and a glass lens 13 having a resin coated on the surface, cementing the first material layer 11 side of the glass lens 10 and the resin side of the glass lens 13, and curing the resin on the glass lens 13 side. For example, it is possible to employ a method of forming the shape of the first material layer 11 into a mold by cutting or the like and transferring the shape to the resin by a molding process such as ultraviolet curing, thermosetting, or injection molding.

The first material layer 11 has a plurality of projected structures Sₙ (n is 1 to 10) on the surface opposite to the glass lens 10 side (10 in the examples of FIGS. 1 and 2). The structures Sₙ each are configured to protrude from a position of an imaginary line L1 perpendicular to the direction A shown in FIG. 1 toward the second material layer 12.

As shown in FIG. 2, a structure S₁ has a circular shape in a plan view. As shown in FIG. 1, a height of the structure S₁ is maximum at an outer peripheral edge (distance from the imaginary line L1 in the direction A), and a height thereof is the lowest value (greater than 0) at an inner center of the outer peripheral edge. The structure S₁ has a recessed portion D₁ inside the outer peripheral edge.

As shown in FIG. 2, the structure Sₖ (k is in a range of 2 to 10) has an annular shape in a plan view. As shown in FIG. 1, a height of the structure Sₖ is the maximum at the outer peripheral edge and the minimum value (=0) at an inner peripheral edge. Therefore, the recessed portion Dₖ is formed between the structure Sₖ and a structure Sₖ₋₁ adjacent to the inner peripheral edge side thereof. In the example of FIG. 1, heights of the outer peripheral edges of the structure Sₙ are all equal, and an imaginary line L2 connecting the outer peripheral edges is shown. Recessed portions Dₙ are regions each of which is recessed from the imaginary line L2 toward the imaginary line L1. A distance from the imaginary line L2 to the end part of each recessed portion Dₙ on the glass lens 10 side (that is, the imaginary line L1) is hereinafter referred to as a depth of the recessed portion Dₙ.

The outer peripheral edges of the structures Sₙ form a diffractive grating shape of the first material layer 11. Specifically, as shown in FIG. 2, in a plan view from the direction D, a shape of the diffractive grating consisting of a plurality of concentric annular ring zones Rₙ (n is 1 to 10) is formed on the first material layer 11. The ring zones Rₙ are composed of the outer peripheral edges of the structures Sₙ. In the following, a radius or a diameter of each ring zone Rₙ is generically referred to as a diameter of the ring zone Rₙ.

In the following description, a distance between the ring zone Rₙ and the ring zone Rₙ₊₁ in a case where an upper limit value of n is 9 will be described as a distance Pₙ. The distance Pₙ corresponds to a width of a recessed portion Dₙ₊₁ in the direction B. That is, a distance P₁ corresponds to a width of a recessed portion D₂ in the direction B, a distance P₂ corresponds to a width of a recessed portion D₃ in the direction B, a distance P₃ corresponds to a width of a recessed portion D₄ in the direction B, a distance P₄ corresponds to a width of a recessed portion D₅ in the direction B, a distance P₅ corresponds to a width of a recessed portion D₆ in direction B, a distance P₆ corresponds to a width of a recessed portion D₇ in direction B, a distance P₇ corresponds to a width of a recessed portion D₈ in direction B, a distance P₈ corresponds to a width of a recessed portion D₉ in the direction B, and a distance P₉ corresponds to a width of a recessed portion D₁₀ in the direction B.

Some diffractive optical elements do not have a structure in the vicinity of the optical axis. For example, a configuration in which the structure S₁ in the diffractive optical element 100 of FIG. 1 is deleted will be described as a reference configuration. This reference configuration is regarded as a configuration in which a diameter of an innermost ring zone R₂ (in other words, the width of the recessed portion D₂ formed inside the ring zone R₂) is greater than each of the distances P₂ to P₉ corresponding to the widths of the other recessed portions D₃ to D₁₀.

In this reference configuration, the width of the recessed portion in the direction B of the innermost structure S₂ is large. Therefore, a shrinkage stress of the resin in a case where the second material layer 12 is cured acts strongly on the recessed portions. As a result, the glass lens 13 tends to be recessed in the vicinity of the optical axis thereof, and it is difficult to obtain desired optical characteristics.

On the other hand, in the diffractive optical element 100, the structure S₁ is provided in the vicinity of the optical axis. Therefore, as compared with the reference configuration, the structure S₁ is able to reduce a volume of the recessed portion existing in the vicinity of the optical axis. Therefore, the shrinkage of the resin in a case where the second material layer 12 is cured in the vicinity of the optical axis can be suppressed by the structure S₁. As a result, the glass lens 13 is prevented from being recessed in the vicinity of the optical axis, and it is possible to obtain desired optical characteristics.

The effect of such a structure S₁ can obtained by preventing the diameter of the innermost ring zone R₁ (that is, the width of the recessed portion D₁) from being the maximum among the widths of all the recessed portions Dₙ. In other words, the above effect can be obtained in a case where the diameter of the ring zone R₁ is less than any one of the distances P₁ to P₉ corresponding to the widths of the other recessed portions Dₖ. Further, in other words, the above effect can be obtained in a case where the diameter of the ring zone R₁ is less than the maximum value among the distances P₁ to P₉ corresponding to the widths of the other recessed portions Dₖ.

The above effect can be obtained even in a case where a depth of the recessed portion D₁ is equal to depths of the other recessed portions Dₖ. However, like the diffractive optical element 100, it is preferable that the depth of the recessed portion D₁ is less than the depths of the other recessed portions Dₖ. With such a configuration, the volume of the recessed portion D₁ can be reduced, and the shrinkage stress can be more strongly relaxed. Further, it is possible to improve the optical characteristics such as the diffraction efficiency of the diffractive optical element 100.

Further, in the diffractive optical element 100, the distance P₁ is greater than a radius of the ring zone R₁. With such a configuration, in a case where the diffractive optical element 100 is applied to a lens disposed on the subject side in a lens device such as a camera, desired optical characteristics can be satisfied.

Further, in the diffractive optical element 100, the distance P₁ is the maximum among all the distances Pk. With such a configuration, in a case where the diffractive optical element 100 is applied to a lens disposed on the subject side in the above lens device, desired optical characteristics can be satisfied.

The distance P₁, (however, the upper limit of n is 9) may be reduced as a value of n increases. In such a manner, the desired optical characteristics can be satisfied.

In the example of FIG. 1, the heights of the outer peripheral edges of the structure Sₙ are all equal. However, in order to adjust the optical path length (phase shift) of the diffractive optical element 100, for example, the height of the outer peripheral edge of the structure S₁ may be different from the height of the outer peripheral edge of the other structure Sₖ.

For example, it is assumed that the diffractive optical element 100 has an error of a projection of 35 nm on the transmitted wavefront. In such a case, the required correction amount ΔW (=−35 nm) of the transmitted wavefront is expressed by Expression (F0), where Δd is the adjustment amount of the height of the outer peripheral edge of the structure S₁.

ΔW=(N2−N1)×Δd (F0)

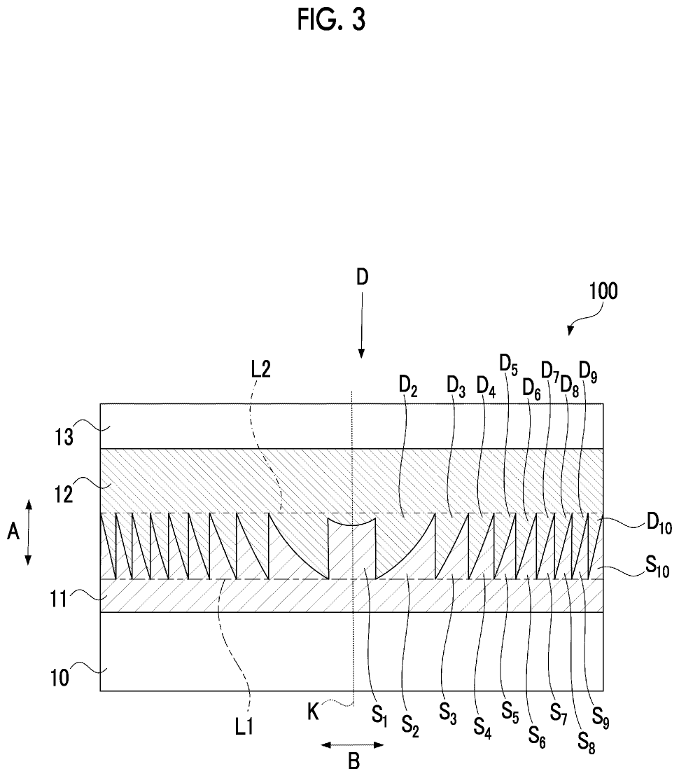

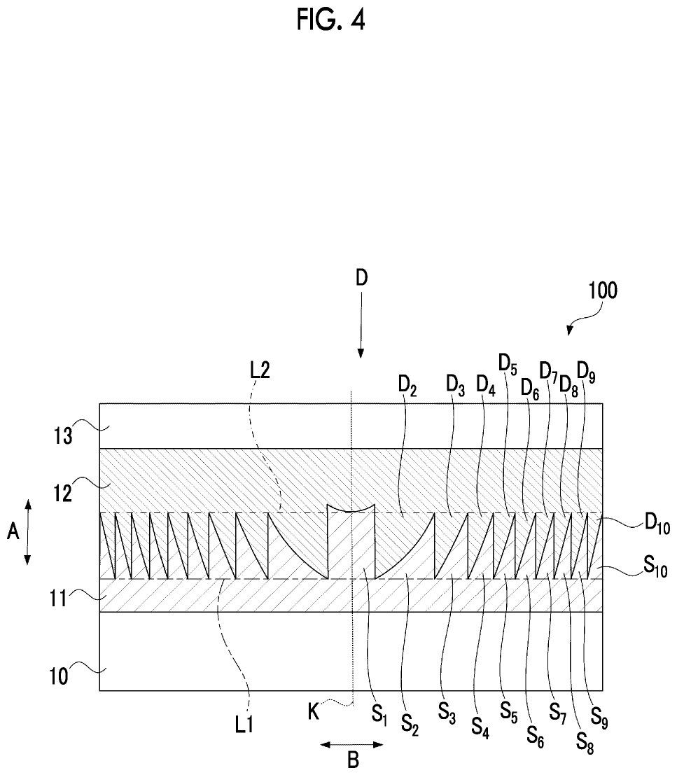

In a case where the refractive index N1 of the first material layer 11 is less than the refractive index N2 of the second material layer 12, an adjustment amount Δd is a negative value. That is, as shown in FIG. 3, by making the height of the outer peripheral edge of the structure S₁ less than the height of the outer peripheral edge of the other structure Sₖ by the absolute value of the adjustment amount Δd, the error of the transmitted wavefront can be eliminated. On the other hand, in a case where the refractive index N1 of the first material layer 11 is greater than the refractive index N2 of the second material layer 12, the adjustment amount Δd is a positive value. That is, as shown in FIG. 4, by making the height of the outer peripheral edge of the structure S₁ greater than the height of the outer peripheral edge of the other structure Sₖ by the absolute value of the adjustment amount Δd, the error of the transmitted wavefront can be eliminated.

In the example of FIG. 1, the distance P₁ is the maximum among the distances P₁ to P₉. Therefore, in order to prevent the diameter of the ring zone R₁ (that is, the width of the recessed portion D₁) from becoming the maximum among the widths of all the recessed portions Dₙ, the condition in which the radius of the ring zone R₁ is less than the distance P₁ may be satisfied.

The shape D(Sₙ) of the structure Sₙ of the first material layer 11 can be defined in Expression (F1) obtained by dividing MOD(rₙ)×λ by 2π×Δn. Here, λ is a reference wavelength determined by the application of the diffractive optical element 100 and the like, Δn is a difference (=N1−N2) in refractive index between the first material layer 11 and the second material layer 12, φ(rₙ) is an even-order phase difference function at the radius (hereinafter referred to as “rₙ”) of the ring zone Rₙ as a variable, C is a start phase of the phase difference function, and MOD(rₙ) is a remainder obtained by dividing the added value of φ(rₙ) and C by 2π. The shape of the structure Sₙ can be designed in accordance with this expression D(Sₙ), and the first material layer 11 can be formed on the glass lens 10 by a mold or the like on the basis of the design result.

D(Sₙ)={MOD(rₙ)×λ}/{2π×Δn} (F1)

The phase difference function φ(rₙ) is expressed by Expression (F2) as an example. The C₂, C₄, C₆, C₈, and C₁₀ in Expression (F2) are predetermined coefficients, respectively. As the phase difference function used for designing the shape of the structure Sₙ, it is desirable to use one having no extreme value in the optical effective diameter range of the diffractive optical element 100, as exemplified by Expression (F2). In such a manner, chromatic aberration can be corrected. In a case of a special use as the diffractive optical element 100 such as an ultra-low profile lens such as a small imaging module used in a mobile phone or an in-vehicle device or an ultra-wide-angle lens used in a projector, it should be noted that the phase difference function may have extreme values.

φ(rₙ)=C₂rₙ²+C₄rₙ⁴+C₆rₙ⁶+C₈rₙ⁸+C₁₀rₙ¹⁰ (F2)

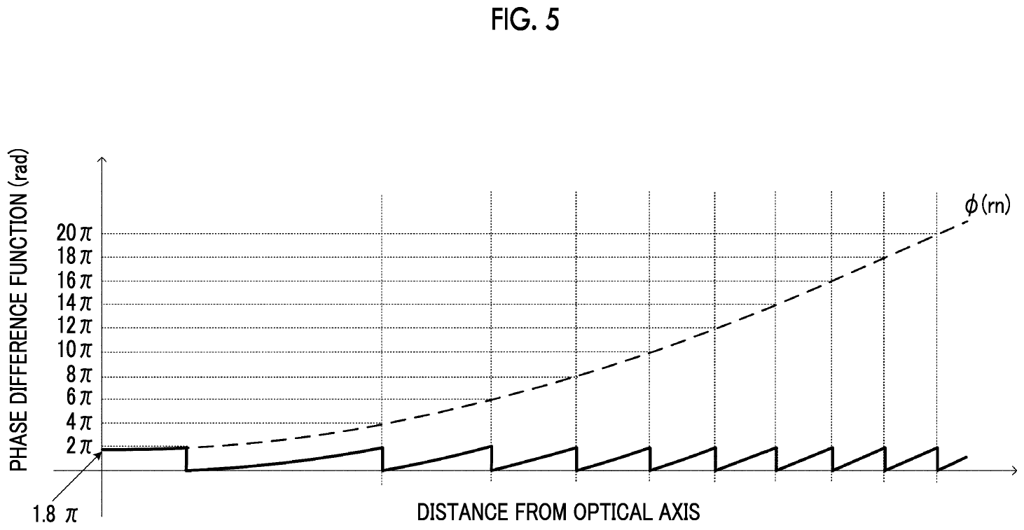

FIG. 5 is a schematic diagram for explaining a graph of the phase difference function φ(rₙ) and an example of the shape of the structure Sₙ determined on the basis of the graph. The horizontal axis of FIG. 5 indicates a distance from the optical axis K in the direction B of the diffractive optical element 100 of FIG. 1. The vertical axis of FIG. 5 shows a value of the phase difference function φ(rₙ). The thick solid line in FIG. 5 schematically shows a shape of the structure Sₙ. Since the graph of the phase difference function has a symmetrical shape, only half of the graph is shown in FIG. 5.

In the example of FIG. 5, the distance, at which the value of the phase difference function φ(rₙ) is a multiple of 2π, is defined as the radius of the ring zone Rₙ. Further, in the example of FIG. 5, the start phase C (a value in a case where the radius is 0) is 1.8π, which is greater than 0. The start phase C is a value corresponding to the depth of the recessed portion D₁. In a case where this value is greater than 0, the depth of the recessed portion D₁ can be made less than the depth of the other recessed portion Dₖ.

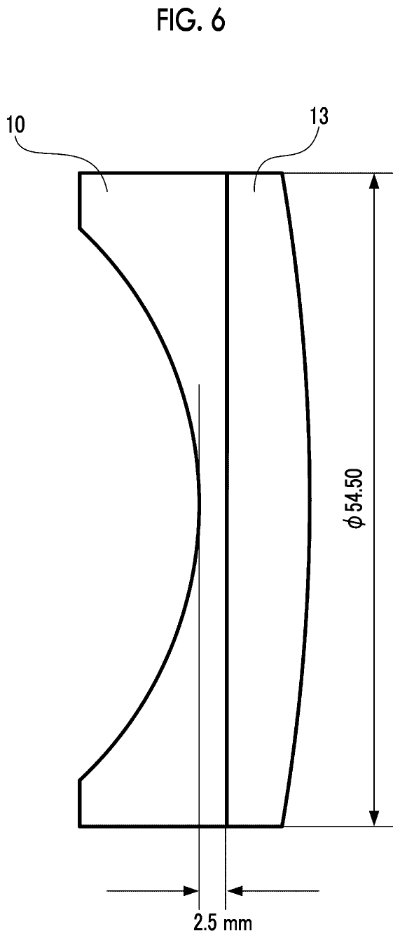

Hereinafter, results of inspection of the diffractive optical element 100 will be described with reference to FIGS. 6 to 12. The materials, amounts, ratios, treatment contents, treatment procedures, and the like shown below can be appropriately modified without departing from the spirit of the present invention. It should be understood that the scope of the present invention is not limited by the specific examples shown below.

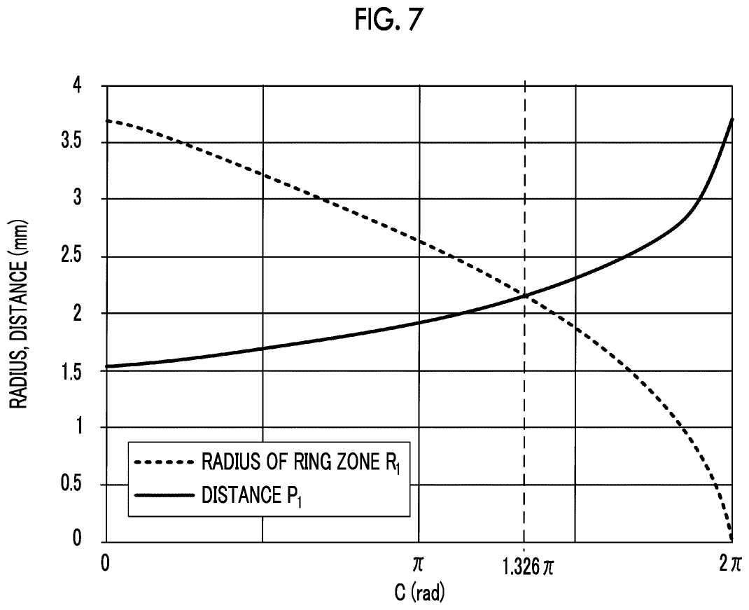

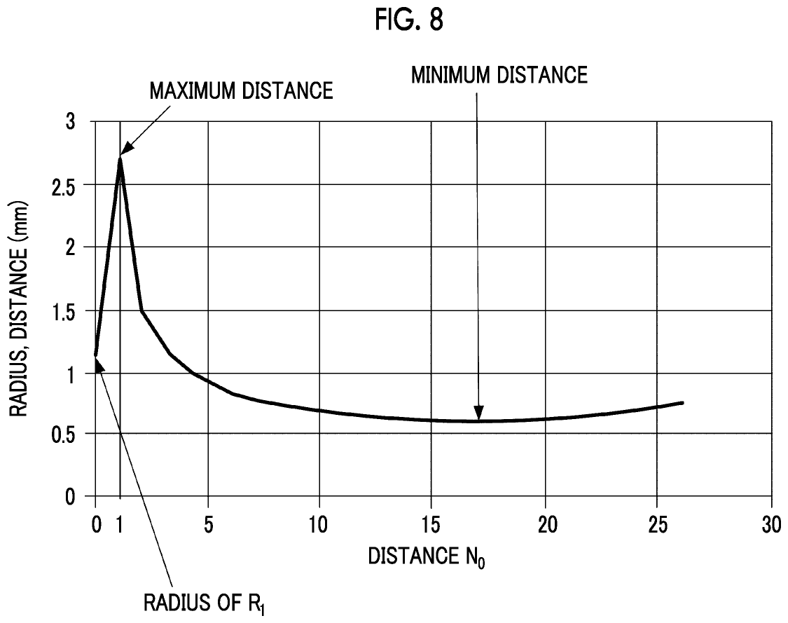

FIG. 6 is a schematic diagram showing a configuration of a diffractive optical element of a first inspection example. As shown in FIG. 6, in the first inspection example, the diameter of the diffractive optical element is 54.50 mm (the optical effective diameter is 44 mm), and the distance between the surface of the glass lens 10 on the optical axis position opposite to the glass lens 13 side and the surface of the glass lens 13 on the glass lens 10 side is 2.5 mm. Further, in the first inspection example, in Expression (F2), C₂ is −0.45934, C₄ is 0.000276, and C₆, C₈, and C₁₀ are 0. By using the phase difference function φ(rₙ) under the above-mentioned assumption, at λ of 633 nm and Δd of 0.06, the start phase C is changed between 0 and a to design the shape of the structure Sₙ. FIG. 7 shows the change of the radius and the distance P₁ of the ring zone R₁ with respect to the start phase C in the first inspection example. FIG. 8 is a diagram showing the distance Pⱼ (j=0, 1, 2, 3, . . . ) between the structures So in a case where the start phase C is 1.8π in the first inspection example. It should be noted that a value corresponding to the distance P₀ is the radius of the ring zone R₁.

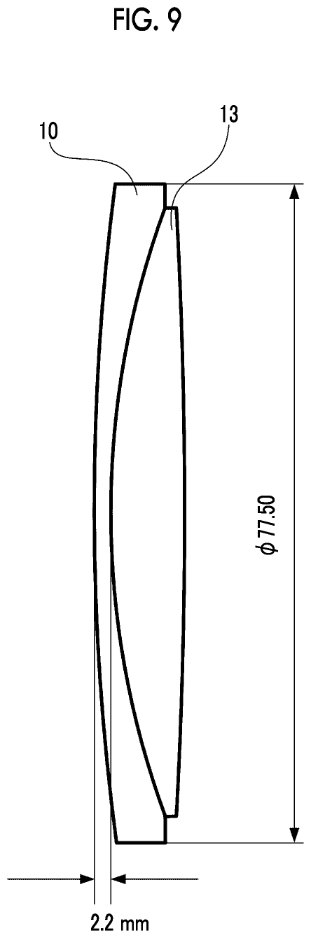

FIG. 9 is a schematic diagram showing a configuration of a diffractive optical element of a second inspection example. As shown in FIG. 9, in the second inspection example, the diameter of the diffractive optical element is 77.50 mm (the optical effective diameter is 56 mm), and the distance between the surface of the glass lens 10 on the optical axis position opposite to the glass lens 13 side and the surface of the glass lens 13 on the glass lens 10 side is 2.2 mm. In the second inspection example, in Expression (F2), C₂ is −0.19824, C₄ is 2.37×10⁻⁵, C₆ is 2.31×10⁻⁹, C₈ is −1.7336×10⁻¹¹, and C₁₀ is 1.09×10⁻¹⁴. By using the phase difference function φ(rₙ) under the above-mentioned assumption, λ is 633 nm.

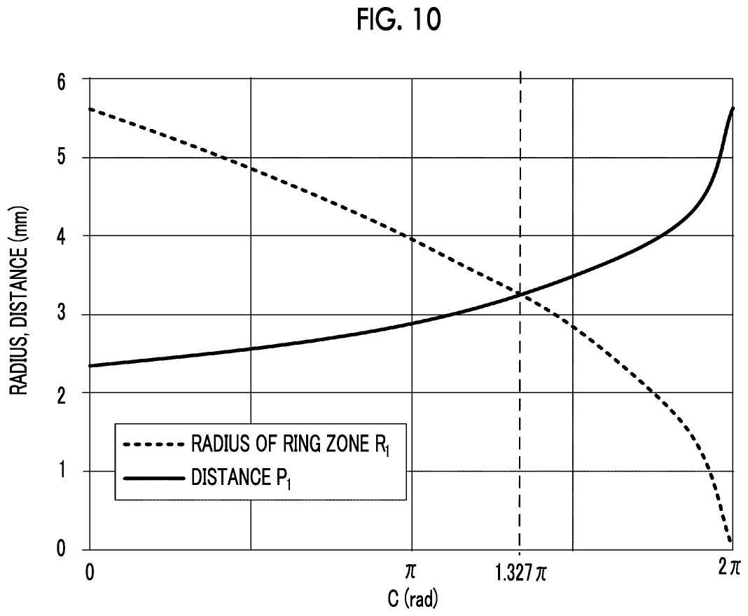

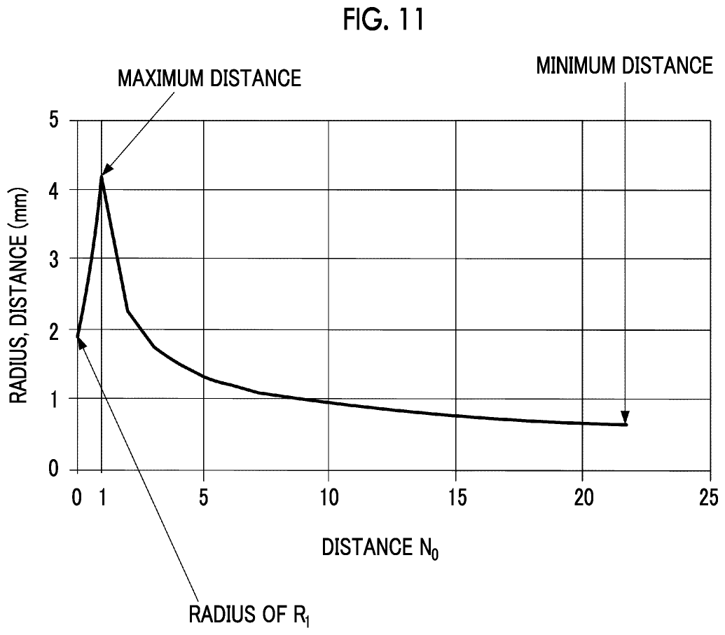

By setting Δd to 0.06 and changing the start phase C between 0 and 2π, the shape of the structure Sₙ is designed. FIG. 10 shows the change of the radius and the distance P₁ of the ring zone R₁ with respect to the start phase C in the second inspection example. FIG. 11 is a diagram showing the distance Pⱼ (j=0, 1, 2, 3, . . . ) between the structures Sₙ in a case where the start phase C is 1.8π in the second inspection example. It should be noted that a value corresponding to the distance P₀ is the radius of the ring zone R₁.

In order to satisfy the condition in which the radius of the ring zone R₁ is less than the distance P₁, as shown in FIGS. 7 and 10, the start phase C may be set to a value greater than a value (a value of the start phase C corresponding to the intersection of the two graphs in FIG. 7 (FIG. 10)) of the start phase C at which the radius of the ring zone R₁ and the distance P₁ are equal. In the example of FIG. 7, by setting the start phase C to a value of greater than 1.326π and less than 2π, the above conditions can be satisfied, for example, as shown in FIG. 8. In the example of FIG. 10, by setting the start phase C to a value of greater than 1.327π and less than 2π, the above conditions can be satisfied, for example, as shown in FIG. 11.

In the first inspection example, a material of the glass lens 10 and the glass lens 13 is BSC7 (manufactured by HOYA Corporation). In this case, results of manufacturing the diffractive optical element 100 with the start phase C as 1.8π will be described as Example 1. The shape error from the design value at the optical axis position of the diffractive optical element 100 of Example 1 was a recess of 20 nm, and the error from the design value at the transmitted wavefront at this optical axis position was 10 nm or less.

In the first inspection example, the material of the glass lens 10 and the glass lens 13 is BSC7, and the start phase C is 0π. In this case, results of manufacturing the diffractive optical element 100 will be described as Reference Example 1a. The shape error from the design value at the optical axis position of the diffractive optical element 100 of Reference Example 1a was a recess of 60 nm, and the error from the design value at the transmitted wavefront at this optical axis position was a projection of 30 nm.

In the second inspection example, the material of the glass lens 10 is S-LAH55V (manufactured by OHARA Corporation), the material of the glass lens 13 is S-FPL51 (manufactured by OHARA Corporation), and the start phase C is 1.8π. In this a case, the results of manufacturing the diffractive optical element 100 will be described as Example 2. The shape error from the design value at the optical axis position of the diffractive optical element 100 of Example 2 was a recess of 40 nm, and the error from the design value at the transmitted wavefront at this optical axis position was a projection of 35 nm.

In the second inspection example, the material of the glass lens 10 is S-LAH55V, the material of the glass lens 13 is S-FPL51, and the start phase C is 0π. In this case, the results of manufacturing the diffractive optical element 100 will be described as Reference Example 2a. The shape error from the design value at the optical axis position of the diffractive optical element 100 of Reference Example 2a was a recess of 100 nm, and the error from the design value at the transmitted wavefront at this optical axis position was a projection of 80 nm.

In the second inspection example, the material of the glass lens 10 is S-LAH55V, the material of the glass lens 13 is S-FPL51, the start phase C is 1.8π, and the height of the structure S₁ is higher than the design value. In this case, the results of manufacturing the diffractive optical element 100 by achieving reduction in size by 58.4 nm will be described as Example 3. The shape error from the design value at the optical axis position of the diffractive optical element 100 of Example 3 was 10 nm or less, and the error from the design value at the transmitted wavefront at this optical axis position was 10 nm or less.

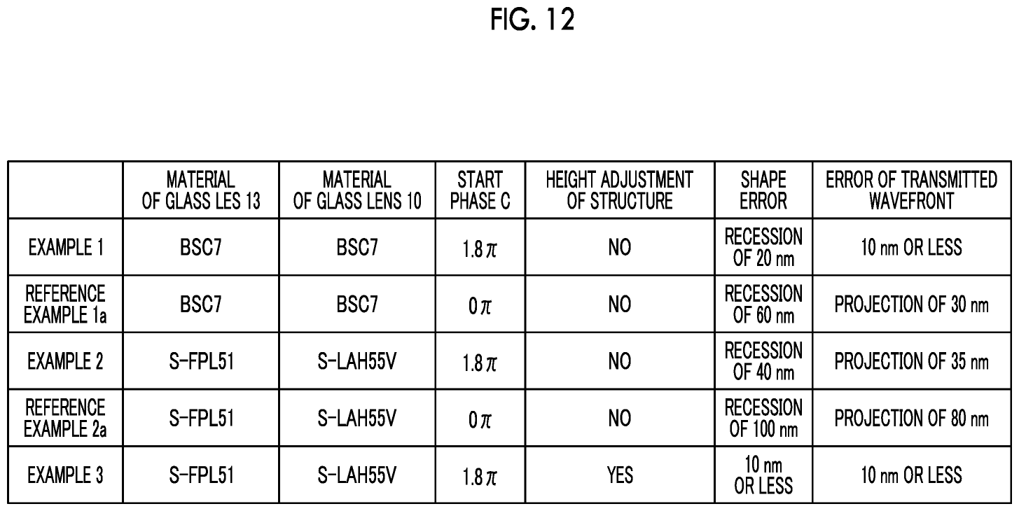

The results of summarizing each of the above examples are shown in FIG. 12. In the examples and reference examples of FIG. 12, the acrylate monomer in which ITO nanoparticles were dispersed was used as the second material layer 12 on the glass lens 13 side, and the acrylate monomer in which ZrO2 nanoparticles were dispersed was used as the first material layer 11 on the glass lens 10 side. From this result, it can be seen that the shape error and the error of the transmitted wavefront can be reduced by setting the start phase C to a value of greater than 0. In addition, it can be seen that the shape error and the error of the transmitted wavefront can be further reduced by adjusting the height of the structure S₁.

In the description hitherto given, the shape of the ring zone Rₙ has been described as a circular shape, but the circular shape in the present specification is a concept including not only a perfect circle but also a tolerance. The radius of the ring zone Rₙ in a case where the shape of the ring zone Rₙ is not a perfect circle is a half of a linear distance between an optional point on the ring zone Rₙ and a point on the ring zone Rₙ farthest from the one point as viewed in a plan view. The diameter of the ring zone Rₙ in a case where the shape of the ring zone Rₙ is not a perfect circle is a linear distance between an optional point on the ring zone Rₙ and a point on the ring zone Rₙ farthest from the one point as viewed in a plan view.

In a similar manner, the plurality of concentric annular ring zones Rₙ is a concept in which the shape of each ring zone Rₙ includes not only a perfect circle but also a tolerance. The centers of the concentrically disposed ring zones Rₙ are at not exactly the same position and may include tolerances.

The shape of the ring zone Rₙ may be, for example, an ellipse. The radius in a case where the shape of the ring zone Rₙ is an ellipse is a half of the linear distance between an optional point on the ring zone Rₙ and a point where an extension of a straight line connecting the point and the center of the ellipse intersects the ellipse as viewed in a plan view. The diameter in a case where the shape of the ring zone Rₙ is an ellipse is a linear distance between an optional point on the ring zone Rₙ and a point where an extension of a straight line connecting the one point and the center of the ellipse intersects the ellipse as viewed in a plan view.

The diffractive optical element 100 may be cut and applied to the product as necessary. For example, a part outside the ring zone R₅ may be cut to make a final product.

As described above, the present description discloses the following items. The constituent elements and the like corresponding to the above-mentioned embodiments are shown in parentheses, but the present invention is not limited thereto.

(1)

In a diffractive optical element (diffractive optical element 100) including: a first material layer (first material layer 11) that has a diffractive grating shape; and a second material layer (second material layer 12) that is laminated on the first material layer, the diffractive grating shape forming a plurality of concentric annular ring zones (ring zone Rₙ) in a plan view from a lamination direction (direction D) of the first material layer and the second material layer,

a radius of an innermost first ring zone (ring zone R₁) among the plurality of ring zones is less than any one of distances between the ring zones.

(2)

In the diffractive optical element according to (1),

a diameter of the first ring zone is less than any one of the distances between the ring zones.

(3)

In the diffractive optical element according to (1),

a radius of the first ring zone is less than a maximum value of the distances between the ring zones.

(4)

In the diffractive optical element according to any one of (1) to (3),

a first distance (distance P₁) between the first ring zone and the second ring zone (ring zone R₂) adjacent to the first ring zone is greater than the radius of the first ring zone.

(5)

In the diffractive optical element according to (4),

the first distance is the maximum among the distances between the ring zones.

(6)

In the diffractive optical element according to any one of (1) to (5),

a depth of a recessed portion (recessed portion D₁) inside the first ring zone in a structure (structure S₁) forming the first ring zone is less than a depth of a recessed portion between structures forming the respective ring zones.

(7)

In the diffractive optical element according to any one of (1) to (6),

in a case where, assuming that
a reference wavelength is λ,
a difference in refractive index between the first material layer and the second material layer is Δn,
a radius of each ring zone is r (rₙ),
an even-order phase difference function at the radius as a variable is φ(r) (φ(rₙ)),
a start phase of the phase difference function is C, and
a remainder obtained by dividing the added value of φ(r) and C by 2π is MOD(r) (MOD(rₙ)), and
a shape of a structure forming each ring zone is defined by Expression obtained by dividing MOD(r)×λ by 2π×Δn,
C is greater than 0 and less than 2π.

(8)

In the diffractive optical element according to any one of (1) to (7),

a height of a structure forming the first ring zone is different from a height of a structure forming each ring zone other than the first ring zone.

(9)

In the diffractive optical element according to (8),

a refractive index of the first material layer is less than a refractive index of the second material layer, and

the height of the structure forming the first ring zone is less than the height of the structure forming each ring zone other than the first ring zone.

(10)

In the diffractive optical element according to (8),

a refractive index of the first material layer is greater than a refractive index of the second material layer, and

the height of the structure forming the first ring zone is greater than the height of the structure forming each ring zone other than the first ring zone.

(11)

In the diffractive optical element according to any one of (1) to (10),

a distance between the ring zones is narrower at a position closer to an outside thereof than a center thereof.

(12)

A diffractive optical element comprising: a first material layer that has a diffractive grating shape; and a second material layer that is laminated on the first material layer, the diffractive grating shape forming a plurality of concentric annular ring zones in a plan view from a lamination direction of the first material layer and the second material layer,

in a case where, assuming that
a reference wavelength is λ,
a difference in refractive index between the first material layer and the second material layer is Δn,
a radius of each ring zone is r,
an even-order phase difference function at the radius as a variable is φ(r),
a start phase of the phase difference function is C, and
a remainder obtained by dividing the added value of φ(r) and C by 2π is MOD(r), and
a shape of a structure forming each ring zone is defined by Expression obtained by dividing MOD(r)×λ by 2π×Δn,
C is greater than 0 and less than 2π.

(13)

In the diffractive optical element according to (12),

C is greater than a value of C at which a radius of an innermost first ring zone among the plurality of ring zones and a distance between the first ring zone and a second ring zone adjacent to the first ring zone are equal.

(14)

In the diffractive optical element according to (12) or (13), the phase difference function has no extreme value in an optical effective diameter range.

(15)

A method of manufacturing a diffractive optical element having a first material layer that has a diffractive grating shape and a second material layer that is laminated on the first material layer, the diffractive grating shape forming a plurality of concentric annular ring zones in a plan view from a lamination direction of the first material layer and the second material layer, the method comprising

forming a radius of an innermost first ring zone among the plurality of ring zones to be less than any one of distances between the adjacent ring zones.

(16)

A method of manufacturing a diffractive optical element having a first material layer that has a diffractive grating shape and a second material layer that is laminated on the first material layer, the diffractive grating shape forming a plurality of concentric annular ring zones in a plan view from a lamination direction of the first material layer and the second material layer, the method comprising

in a case where, assuming that
a reference wavelength is λ,
a difference in refractive index between the first material layer and the second material layer is Δn,
a radius of each ring zone is r,
an even-order phase difference function at the radius as a variable is φ(r),
a start phase of the phase difference function is C, and
a remainder obtained by dividing the added value of φ(r) and C by 2π is MOD(r), and
a shape of a structure forming each ring zone is defined by Expression obtained by dividing MOD(r)×λ by 2π×Δn,

designing the structure in a state where C is greater than 0 and less than 2π, and

forming the diffractive grating shape in accordance with the design.

(17)

In the method of manufacturing a diffractive optical element according to (16),

C is greater than a value of C at which a radius of a first ring zone having a smallest diameter among the plurality of ring zones and a distance between the first ring zone and a second ring zone adjacent to the first ring zone are equal.

Although various embodiments have been described above with reference to the drawings, it is needless to say that the present invention is not limited to such examples. It is apparent to those skilled in the art that various variations or modifications can be made within the scope of the claims, and it should be understood that such variations or modifications belong to the technical scope of the invention. Further, each constituent element in the above-mentioned embodiment may be arbitrarily combined without departing from the spirit of the invention.

This application is on the basis of a Japanese patent application filed on Mar. 31, 2020 (Japanese Patent Application No. 2020-063803), the contents of which are incorporated herein by reference.

### EXPLANATION OF REFERENCES

L1, L2: imaginary line L
S₁ to S₁₀: structure
R₁ to R₁₀: ring zone
D₁ to D₁₀: recessed portion
P₁ to P₉: distance
10, 13: glass lens
11: first material layer
12: second material layer
100: diffractive optical element
K: optical axis

What is claimed is:

1. A diffractive optical element comprising: a first material layer that has a diffractive grating shape; and a second material layer that is laminated on the first material layer, the diffractive grating shape forming a plurality of concentric annular ring zones in a plan view from a lamination direction of the first material layer and the second material layer,
wherein a radius of an innermost first ring zone among the plurality of ring zones is less than any one of distances between the ring zones.

2. The diffractive optical element according to claim 1,
wherein a diameter of the first ring zone is less than any one of the distances between the ring zones.

3. The diffractive optical element according to claim 1,
wherein a radius of the first ring zone is less than a maximum value of the distances between the ring zones.

4. The diffractive optical element according to claim 1,
wherein a first distance between the first ring zone and a second ring zone adjacent to the first ring zone is greater than the radius of the first ring zone.

5. The diffractive optical element according to claim 4,
wherein the first distance is maximum among the distances between the ring zones.

6. The diffractive optical element according to claim 1,
wherein a depth of a recessed portion inside the first ring zone in a structure forming the first ring zone is less than a depth of a recessed portion between structures forming the respective ring zones.

7. The diffractive optical element according to claim 1,
wherein, in a case where, assuming that
a reference wavelength is λ,
a difference in refractive index between the first material layer and the second material layer is Δn,
a radius of each of the ring zones is r,
an even-order phase difference function at the radius as a variable is φ(r),
a start phase of the phase difference function is C, and
a remainder obtained by dividing an added value of φ(r) and C by 2π is MOD(r), and
a shape of a structure forming each of the ring zones is defined by Expression obtained by dividing MOD(r)×λ by 2π×Δn,
C is greater than 0 and less than 2π.

8. The diffractive optical element according to claim 1,
wherein a height of a structure forming the first ring zone is different from a height of a structure forming each of the ring zones other than the first ring zone.

9. The diffractive optical element according to claim 8,
wherein a refractive index of the first material layer is less than a refractive index of the second material layer, and
the height of the structure forming the first ring zone is less than the height of the structure forming each of the ring zones other than the first ring zone.

10. The diffractive optical element according to claim 8,
wherein a refractive index of the first material layer is greater than a refractive index of the second material layer, and
the height of the structure forming the first ring zone is greater than the height of the structure forming each of the ring zones other than the first ring zone.

11. The diffractive optical element according to claim 1,
a distance between the ring zones is narrower at a position closer to an outside thereof than a center thereof.

12. A diffractive optical element comprising: a first material layer that has a diffractive grating shape; and a second material layer that is laminated on the first material layer, the diffractive grating shape forming a plurality of concentric annular ring zones in a plan view from a lamination direction of the first material layer and the second material layer,
wherein, in a case where, assuming that
a reference wavelength is λ,
a difference in refractive index between the first material layer and the second material layer is Δn,
a radius of each of the ring zones is r,
an even-order phase difference function at the radius as a variable is φ(r),
a start phase of the phase difference function is C, and
a remainder obtained by dividing an added value of φ(r) and C by 2π is MOD(r), and
a shape of a structure forming each of the ring zones is defined by Expression obtained by dividing MOD(r)×λ by 2π×Δn,
C is greater than 0 and less than 2π.

13. The diffractive optical element according to claim 12,
wherein C is greater than a value of C at which a radius of an innermost first ring zone among the plurality of ring zones and a distance between the first ring zone and a second ring zone adjacent to the first ring zone are equal.

14. The diffractive optical element according to claim 12,
wherein the phase difference function has no extreme value in an optical effective diameter range.

15. A method of manufacturing a diffractive optical element having a first material layer that has a diffractive grating shape and a second material layer that is laminated on the first material layer, the diffractive grating shape forming a plurality of concentric annular ring zones in a plan view from a lamination direction of the first material layer and the second material layer, the method comprising:
forming a radius of an innermost first ring zone among the plurality of ring zones to be less than any one of distances between the adjacent ring zones.

16. A method of manufacturing a diffractive optical element having a first material layer that has a diffractive grating shape and a second material layer that is laminated on the first material layer, the diffractive grating shape forming a plurality of concentric annular ring zones in a plan view from a lamination direction of the first material layer and the second material layer, the method comprising:
in a case where, assuming that
a reference wavelength is λ,
a difference in refractive index between the first material layer and the second material layer is Δn,
a radius of each of the ring zones is r,
an even-order phase difference function at the radius as a variable is φ(r),
a start phase of the phase difference function is C, and
a remainder obtained by dividing an added value of φ(r) and C by 2π is MOD(r), and
a shape of a structure forming each of the ring zones is defined by Expression obtained by dividing MOD(r)×λ by 2π×Δn,
designing the structure in a state where C is greater than 0 and less than 2π, and
forming the diffractive grating shape in accordance with the design.

17. The method of manufacturing a diffractive optical element according to claim 16,
wherein C is greater than a value of C at which a radius of a first ring zone having a smallest diameter among the plurality of ring zones and a distance between the first ring zone and a second ring zone adjacent to the first ring zone are equal.
